(19) United States
(12) Patent Application Publication
(10) Pub. No.: US 2023/0298039 A1
(43) Pub. Date: Sep. 21, 2023

(54) METHOD AND SYSTEM FOR PROVIDING LIVE INFORMATION

(71) Applicant: GNM MEDIA LTD., Holon (IL)

(72) Inventors: Evgeni Levin, Rishon Letzion (IL); Michael Plaks, Beer Yaakov (IL)

(73) Assignee: GNM MEDIA LTD., Holon (IL)

(21) Appl. No.: 18/013,826

(22) PCT Filed: Jul. 1, 2021
(86) PCT No.: PCT/IL2021/050809

§ 371 Date: Dec. 29, 2022

Related U.S. Application Data
(60) Provisional application No. 63/047,020, filed on Jul. 1, 2020.

(51) Int. Cl. G06Q 30/015; G06N 20/00

(52) U.S. Cl. CPC G06Q 30/015; G06N 20/00

(57) ABSTRACT

A method for providing live information, comprising: a) scanning data for determining limited data to work on among data sets that are too large or complex to be dealt with; b) drilling down to the following data that correlates with the previously determined limited data until obtaining the desired number of workable live results; and c) saving the results as new data that capture only limited capacity, thereby providing an in-house collection that, due to its limited capacity, information can be retrieved and worked on it live.

### FIELD OF THE INVENTION

The present invention relates to the field of data processing systems. More particularly, the invention relates to a method for providing online artificial intelligence data processing for computing systems where data associated with entities such as persons, organizations, accounts, and similar ones are maintained for various purposes. For example, managing data relative to relationships and interactions with customers and potential customers, such as Customer Relationship Management (CRM) technology solutions, call centers, etc.

### BACKGROUND OF THE INVENTION

There is a significant value in slicing and dicing the opportunities in different data dimensions in a sales process. Breaking down data by different attributes is an essential way to analyze sales team status, uncover resource allocation needs, compare opportunities by categories, and improve forecasting accuracy. Visually showing the data and drilling down into specific areas is valuable to building reports and understanding the state of each of the sales team's opportunities. Having the visual representation data segments linked to the corresponding individual opportunities is convenient and enhances the efficiency of sales processes.

For example, CRM solutions provide tools and capabilities needed to create and maintain a clear picture of customers, from the first contact through purchase and post-sales. CRM system may provide features and capabilities to help improve the way sales, marketing, and/or customer service organizations target new customers, manage marketing campaigns, and drive sales activities. CRM systems may include many components, hardware and software, utilized individually or shared by users internal or external to the organization.

However, as such solutions handle a vast amount of data, it becomes cumbersome to process and analyze in real-time a massive flow of information. Therefore it takes valuable time to provide the user with the data and insights required for a fluent and efficient real-time working process. In other words, such existing solutions lack the ability to provide dynamic data representation and instant insight in real-time while maintaining a vast amount of data.

It is an object of the present invention to provide a system capable of providing dynamic data and insights required for a fluent and efficient working process in real-time.

It is another object of the present invention to provide a system capable of handling a massive flow of information, learning every input provided, and accordingly reacting immediately to any situation.

Other objects and advantages of the invention will become apparent as the description proceeds.

### SUMMARY OF THE INVENTION

A computer-implemented method, comprising the steps of:
a. scanning data for determining limited data to work on among data sets that are too large or complex to be dealt with;
b. drilling down to the next data that correlates with the previously determined limited data until obtaining the desired number of workable live results (e.g., suitable to manage by data-processing application software in real-time);
c. saving the results as new data that capture only limited capacity, thereby providing an in-house collection that, due to its limited capacity, information can be retrieved and worked on it live.

In one aspect, the scan determines the percentage of data to work on among the entire data set.

In another aspect, the percentage of data to work on is about 20% of the entire data set.

In yet another aspect, the desired number of workable live results is up to 1000 workable live results.

According to an embodiment of the invention, a procedure to drill down from the entire data set configured to run until reveling the desired number of workable live results.

According to an embodiment of the invention, the method is applied in parallel on any other pre-determined outcome to receive multiple outlets and save them as very small data capacity, thereby enabling prompt access and visualization.

According to an embodiment of the invention, the method further comprises assigning a number for each obtained result, wherein each result configured with a top number in accordance with applied statistics score that includes: sum, average, top, and low.

According to an embodiment of the invention, the method further comprises:
saving the data daily in a database and using said saved data to access data calculations;
checking new income data and comparing it to the saved summed up file; and
presenting live suggestions based on said saved data.

According to an embodiment of the invention, the method further comprises applying a machine learning process configured for learning from each and every clickable measurement and entered into the database, wherein each click of the button on the system measures time duration.

According to an embodiment of the invention, the machine learning process comprises verifying whether a workflow has an outcome by comparing results and updating accordingly, wherein said process involves the steps of:
Once a suggested parameter has been established, it is marked; [need example]; and
Once in a period, the data is collected and updated in accordance with an assigned top number obtained by applied statistics score that includes: sum, average, top, and low.

According to an embodiment of the invention, the in-house data collection enables cross-platform interaction for live information.

According to an embodiment of the invention, the method further comprises the live information includes data relative to one or more of the following: lead, users, communication, security, marketing, inventory, stats, charts, instructions, shift management, financial, and gamification.

According to an embodiment of the invention, the method further comprises tags-based notifications system, wherein the tags-based notifications system enables to provide real-time data count, timestamp, immediate data filtration and recovery, and speed.

According to an embodiment of the invention, the method further comprises providing positive feedback by gamification (e.g., receiving highest score), charts, ranking (1^{st} places, 2^{nd} places, etc.), providing achievements symbols in any category, and live attention.

In yet another aspect, the invention relates to a system, comprising:
a) at least one processor; and
b) a memory comprising computer-readable instructions which, when executed by the at least one processor, causes the processor to execute an AI workflow, wherein the AI workflow:
   i. scans data for determining limited data to work on among data sets that are too large or complex to be dealt with;
   ii. drills down to the next data that correlates with the previously determined limited data until obtaining the desired number of workable live results suitable to manage by traditional data-processing application software; and
   iii. saves the results as new data that capture only limited capacity, thereby providing an in-house collection that, due to its limited capacity, information can be retrieved and worked on it live.

### BRIEF DESCRIPTION OF THE DRAWINGS

In the drawings:

FIG. 1 is a flow chart generally illustrating the method of the invention;

FIG. 2 schematically illustrates an example of a computing environment in which the invention may be implemented; and

FIGS. 3-5 show screenshot examples of an implementation of the dynamic presentation in a contact center environment, according to an embodiment of the invention.

### DETAILED DESCRIPTION OF THE INVENTION

The following provides a detailed description of embodiments of the method and system of the present invention. The method and system of the present invention, which is generally comprised of software for use in a contact center environment, provides an intelligent desktop experience, guide agent behavior to desired outcomes, and provide behind the scenes data integration of disparate systems using abstracted interfaces to overcome the limitation of hardware and software systems commonly used to handle huge amount of data required to operate contact centers. In the following detailed description, references are made to the accompanying drawings that form a part hereof and which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

Unless otherwise defined, all technical and scientific terms used herein have the same meaning as commonly understood by one of ordinary skill in the art to which this invention belongs. The system, methods, and examples provided herein are illustrative only and not intended to be limiting. Moreover, although the description herein refers to implementation with respect to contact center environment, e.g., that may use worldwide marketing campaigns, keywords, and agents that perform conversation with potential customers (e.g., via a call center), the method of the present invention for providing dynamic and live information, can be applied mutatis mutandis to other data system environments that handle the massive flow of information.

According to an embodiment of the invention, the method is based on an empirical rule called “Pareto principle” or the “80-20 rule”, which states that for many phenomena, 80% of the result comes from 20% of the effort. In other words, this 20-80 rule states that “80% of your profits come from 20% of your customers,” or “80% of incomes of an organization come from 20% of high-income workers,” and “80% of defects come from 20% of causes.” Based on this principle, the present invention provides a computer-implemented method that, instead of working with data sets that are too large or complex to be dealt with, samples only a limited amount of data (i.e., starts with about 20% of the entire data set, and drills down this data using the same principle of the 20-80 rule, until no further drill-down of data can be achieved).

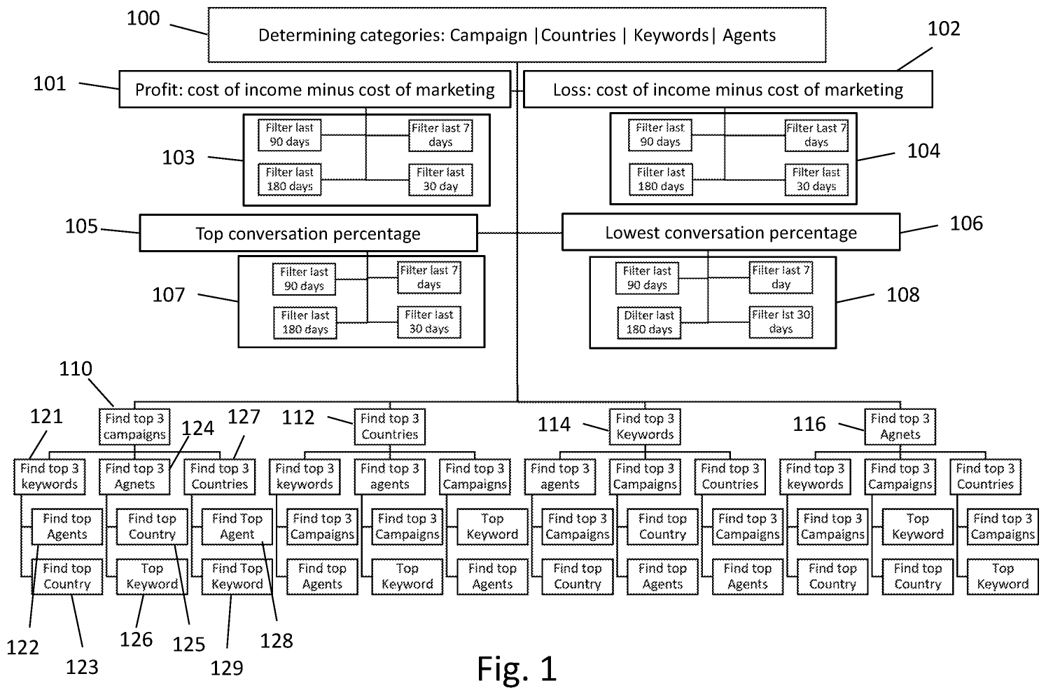

Referring to FIG. 1, a method of providing dynamic information and insights according to the present invention starts at 100, wherein the selection of information for visual representation takes place in accordance with the Pareto principle. Therein information of the highest quality and relevance is preferentially selected over the information of relatively low quality and/or relevance. As a result, a smaller subset of information pertaining to events and circumstances having the greatest impact relating to outcomes (i.e., in this example, events of greatest impacts refers to profit and loss) are isolated from the greater subset of information pertaining to events of relatively low impact. This is based on the assumption that it is not realistic for an organization to identify and understand every combination of cause and effect that is possible. Instead, the system of the present invention enables organizations to reduce the scope of which cause and effect events need to be considered based on its application to the organization and the business risk scenarios. From narrowing the scope cause and effect down (e.g., profit and loss) to only those having the greatest impact, relevant data can be identified and considered for inclusion in a dynamic representation of information, and to enhance the analysis of provided information by further improving its contextual meaning and relevance.

For example, with respect to the contact center environment, such as a call center, the Pareto principle, the 80/20 rule, indicates that: 80% of sales come from 20% of the sales force, and 80% of the work is done by 20% of employees. With this regard, it is assumed that most of the profits and losses in any situation are determined by only a small number of causes.

According to an embodiment of the invention, a method to identify the vital few contributors that account for most quality outcomes may involve the following procedure:
Determining categories to use to group items (bloc 100). For example, in call centers, the categories can be campaigns (e.g., online marketing campaigns), countries, keywords (i.e., words or phrases that are used to match ads with the terms people are searching for. As will be appreciated by a person skilled in the art, selecting high quality, relevant keywords for an advertising campaign can help reach customers one may want), and agents (e.g., a person who handles incoming or outgoing customer calls);
Determining what measurement is appropriate, such as profit and loss (bloc 101 and 102, respectively), wherein each of which can be defined by the cost of income minus cost of marketing and may cover top profits and top losses, as well as the measurement of top conversations (i.e., successful conversations with costumers) and lowest conversation (unsuccessful conversation with costumers) as indicated by blocs 105 and 106, respectively;
Determining what period of time to cover or filter. For example, a week (i.e., seven days), 30 days, 90 days, 180 days, etc. as indicated by bloc 103 for profits, and by bloc 104 for losses, and by blocs 107 and 108 for top and lowest conversations, respectively;
Collecting the data, recording the category each time, or assemble data that already exist, e.g., as the limited data determined by blocs 110, 112, 114, and 116. For example, bloc 110 configured to find top three campaigns as top category, bloc 112 configured to find top three countries as top category, bloc 114 configured to find top three keywords as top category, and bloc 116 configured to find top three agents as a top category;
Drilling down to the next data that correlates with the previously determined data until obtaining the desired number of workable data suitable to provide a dynamic presentation (e.g., that can be managed by the data-processing application software that runs on a computer system with limited processing resources)—for example, collecting data limited to the top three campaigns as found by bloc 110, drilling down to the next data to find the top three keywords (bloc 121) that are correlated with the top three campaigns that have been found in bloc 110. At next, continuing to drill down to find the top agent that correlates with the previously determined data (i.e., with the keywords found in bloc 121) and to find the top countries that correlate with the previously determined data, as indicated by blocs 122 and 123. Such drilling down procedures may apply for other orders of categories, e.g., as indicated by blocs 124, 125 and 126, in which the drill down starts with finding the top three agents (bloc 124), while the following drill-down is configured to find top countries (bloc 125) and top keywords (bloc 126). In blocs 127-129, the drill-down starts with finding the top three countries (bloc 127), followed by finding the top three agents (bloc 128) and finding top keywords (bloc 129). Each group of drill-down blocs, such as blocs 121-123, blocs 124-126, and blocs 127-129 refer herein also as sub-steps; and
Saving data relative to top results of profits, losses, top conversations and lowest conversation that is useful for analysis, communication, and generating the dynamic presentation. This provides limited data to work on among data sets that are too large or complex to be dealt with. As the saved data capture only limited capacity, it provides an in-house data collection that, due to its light capacity, information can be retrieved and worked on it live without affecting system performance in terms of processor (e.g., CPU) usage, memory usage, swap usage, and disk and network throughput (i.e., due to the limited amount of saved data). Therefore, the method of the present can be applied on a personal computer system (e.g., a personal server) and not a supercomputer.

It should also be understood that, unless indicated otherwise, the illustrated order of operations as represented by blocs of the flowchart of FIG. 1 has been selected for the sake of convenience and clarity only. The order of execution of illustrated operations may be modified, or operations of the illustrated method may be executed concurrently, with equivalent results. Such reordering of operations illustrated by blocs of the flowchart should be considered as included within the scope of embodiments of the present invention. Moreover, as will be appreciated by a person skilled in the art, the effectiveness of quality improvement, like almost any activity, reflects the Pareto principle: 80% of the benefit can be achieved by 20% of the effort, and consequently, the last 20% of the benefit is achieved with 80% of the effort.

For operational reporting requiring accurate statistics that will be compared to original source systems, the quality of the data must reflect a high consistency between the data for analysis and the original source. On the other hand, when analyzing very large data sets for unusual patterns or to determine relationships, a small number of errors might not significantly skew the results. For example, many large online retailers might seek to drive increased sales through relationship analysis and the appearance of correlated items within a market basket. If they are looking at millions of transactions a day, and a few show up as incorrect or incomplete, the errors are probably going to be irrelevant.

In bloc 110, the important information is selected using several sub-steps (refers herein as “drilling down”, and, for example, as described hereinabove with respect to blocs 121-123). For example, bloc 121 includes initially selecting information based on its relevance to the finding of bloc 110, and so forth with blocs 122 and 123. Also, sub-steps 121-123 may select information based on internal dynamics (i.e., correlation) of the information that becomes evident during analysis (tracking) of the information over time. Further, these sub-steps may select information based on relevance to hypotheses that are developed during logical and intuitive analysis of information over time, and this process is further described below. Altogether, these sub-steps accomplish the selection of information of high quality and relevance. Moreover, these sub-steps effectively identify the internal dynamics of information concurrent with the presentation of live information.

For example, as new information is received, a footprint trail is developed by the sub-steps, wherein information is analyzed, selected, and linked in relation to issues and/or decisions invoked by previously received, selected, and linked information. This process occurs in real-time, thus ensuring that the important issues and decisions of the day are thoroughly explored, and the information pertaining to them can be dynamically displayed. Together, these sub-steps effectively follow the information stream in real-time.

The real-time organizational and reorganizational process embodied in the sub-steps is promiscuous, in that each of the steps feeds into the operation of the other step. For example, following the information stream in bloc 110 assists in identifying internal dynamics of the information stream, and therefore feeds into the operation of sub-steps 121-123, wherein internal dynamics are respectively utilized for the selection of information for presentation.

According to an embodiment of the invention, the organization of information developed according to this promiscuous process is capable of relating information of greatest importance to issues and decisions of the day. Of great importance, the organized information is not diluted by the presence of relatively insignificant information or information that is out of date. Of equal importance, point count information of each category (e.g., a specific country, campaign, keyword, or an agent) conveyed by the dynamically saved data consistently has an organization developed by a logical and intuitive analysis in view of the latest available information. Thus, among the three top categories, each receives a score (i.e., point count) according to its current place (i.e., 1^{st} place, 2^{nd} place, and 3^{rd} place among the top three).

All the above will be better understood through the following illustrative and non-limitative examples.

For example, a registration has the following values: country, campaign, and keyword. Now, for the found country: if a country is in 1^{st} place, it may receive 3 points, if in 2^{nd} place it may receive 2 points and if in 3^{rd} place it may receive only 1 point). Under agent filtration in any of the 16 scenarios of dates: 7 days|30 days|90 days|180 last days, found the name of the agent that has filtered as 1st place in several locations—for example, if that agent has three times 1^{st} place, the agent will be added with 3 points multiplied by 3 (i.e., a total of 9 points). In the same manner, filtration of the campaign and of keywords can be obtained. Accordingly:
In the positive outcomes—add values (Good Profit|good conversion rate); and
In the negative outcomes—remove values (Bad profits|bad conversion rate).

The outcome can be such that there will be more losing values than profiting ones, and then the system may define that specific agent as a less effective one.

According to an embodiment of the invention, an additional advantage provided by the invention is the generation of a presentation (e.g., in the form of a newspaper) that is capable of providing customized highlights of the previous day (i.e., provides information of anomalies), for example, providing most important information in terms of top scheduled call reasons, top marketing campaigns, top sales personnel, the top product sold, top affiliates, etc.

### An Example of Artificial Intelligence (AI) Workflow

According to an embodiment of the invention, an AI workflow may involve the following procedures:

This workflow has been tested on a personal server (not a supercomputer).
a. Each data starts from a data scan;
b. The scan determents what percentage of data to work on—The idea is to work on 20/80, 20% relevant data and do not work on the 80% that is not relevant;
c. From the received 20% data, it drills down to the next data that correlates with the previous data;
d. At the end of the procedure, the goal is to have up to 1000 workable live results;
e. The procedure to drill down from a vast amount of data can run in the background until obtaining the needed results:
   i. The obtained results are saved as new data; and
   ii. From this new data, due to its very small capacity, any needed information can be retrieved and worked on it live.
f. The system of the present invention does this process parallel on any other pre-determined outcome:
   i. This way, multiple outlets can be received;
   ii. Save them as very small data; and
   iii. Access and visualization are promptly obtained
g. Next step, providing a number for each result;
   i. Each result configured with a top number
   ii. For example, 10 to 1 with this data: sum, average, top, and low any data available
h. Next step, saving the data daily in a database and use this data to access the calculations
i. Interaction logic
   i. Due to a vast amount of data calculation by adding to the calculation: hundreds or thousands new data rows, in % of calculation it will not reflect even by 1%. In this way, the data does not consider as a margin of mistake;
j. Next step, using the data. Checking new income data and compare it to a saved summed up file; and
k. Presenting live suggestions.

According to an embodiment of the invention, the system may learn from each and every clickable measurement (i.e., interaction with the system) and entered it into the database. Each click of the button on the system measured (e.g., time duration).

According to an embodiment of the invention, the system may provide data for checking whether the workflow has an outcome (i.e., an internal “quality assurance” check of the AI workflow). The internal “quality assurance” check may involve the following procedure:

AI data—has a modification that allows comparing results and adjusting itself on accordingly.
a. Once a suggested parameter had been established, it is marked;
b. Once in a period, the data is collected and provided with statistics; and
c. With this statistic, the suggested method may change by the same score statistics that were mentioned hereinabove with respect to section (g) of the AI workflow.

Each software application is usually provided with Application Programming Interface (API), and each software application has its own database. According to an embodiment of the invention, by enabling the in house data collection, the AI may correspond with multiple software applications and provides cross the board live information data that may include: lead, users, communication, security, marketing, inventory, stats, charts, instructions, shift management, financial, gamification, etc.

According to an embodiment of the invention, at least some of the dynamic information can be visually provided in the form of tags-based notifications. Tags-based notifications allow segmentation of notifications based on subject areas or topics. It is important to mention that this an important advantage of the system, as such form of representation in contact center environment was not available up to this point.

The tags-based notifications may provide the following information: data count, timestamp, immediate data filtration and recovery, speed. The tags-based notifications enable the implementation of data with one click as well as recovery of the same data with one click.

According to an embodiment of the invention, the system may provide positive feedback (e.g., Pavlov theory implementation) and competition engagement (e.g., Maslow theory). The dynamic representation may provide technological nonstop positive feedback by gamification, highest score, charts, 1st places, achievements symbols in any category of the business, live attention, etc.

The present invention provides a system capable of providing dynamic data and insights required for a fluent and efficient working process in real-time, in a variety of fields and implementations, such as providing a live income of data for the Soule and result in the purpose of a sale, small business, manufacturing plans, food court, development systems and protocols, astronomy, anatomy, forensics, military divisions. In addition, the system enables the correlation of human scans by face recognition, body language and posture, voice recognition, and coloration of any scan of data.

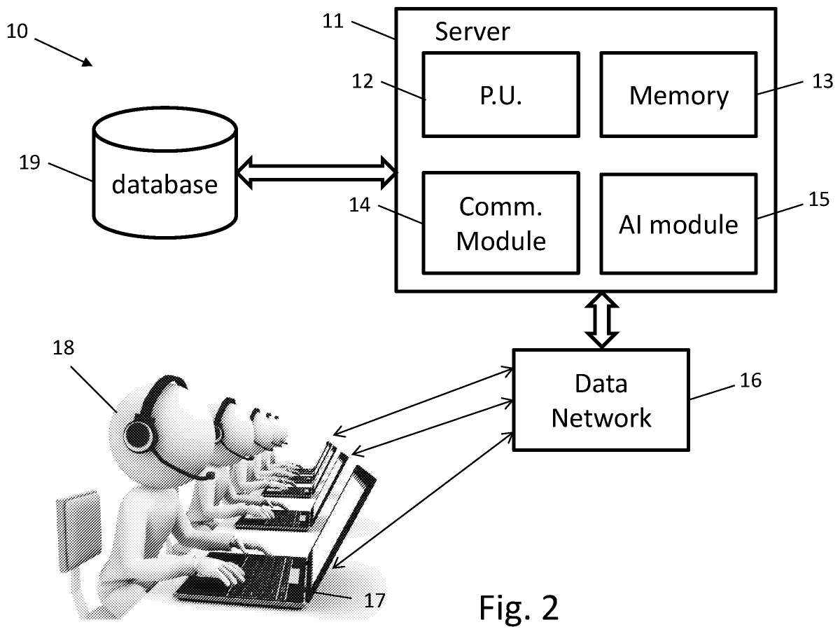

FIG. 2 intended to provide a brief, general description of a suitable computing environment 10 in which the invention may be implemented. While the invention is described in the general context of program modules that execute in conjunction with an application program that runs on an operating system on a processor-based system 11, those skilled in the art will recognize that the invention may also be implemented in combination with other computer systems, including, but not limited to cloud computing system, servers, and the like.

According to an embodiment of the invention, processor-based system 11 comprises a processing unit (PU) 12, a memory 13, a communication module 14, an AI module 15, a data network 16, a plurality of terminal computing devices 17 (e.g., a personal computer configured to act as a call center unit suitable to be operated by an agent 18), and a database 19. Database 19 can be part of server 11 or can be provided as an external unit that may communicate with server 11 via data network 16.

AI module 15 is configured to perform the AI workflow by utilizing the “80-20 rule” on the data originated from database 19, as well as input data received from each terminal computing device 17.

Unless otherwise indicated, the functions that were described hereinabove may be performed by executable code and instructions stored in computer-readable medium and running on one or more processor-based systems. However, state machines and/or hardwired electronic circuits can also be utilized. Further, with respect to the example processes described herein, not all the process states need to be reached, nor do the states have to be performed in the illustrated order. Further, certain process states that are illustrated as being serially performed can be performed in parallel.

Generally, program modules include routines, programs, components, data structures, and other types of structures that perform particular tasks. Moreover, those skilled in the art will appreciate that the invention may be practiced in distributed computing environments where tasks are performed by remote processing devices that are linked through data network 16 or other communication networks. In a distributed computing environment, program modules may be located in both local and remote memory storage devices.

The terms “for example”, “e.g.”, “optionally”, as used herein, are intended to be used to introduce non-limiting examples. While certain references are made to certain example system components or services, other components and services can be used as well and/or the example components can be combined into fewer components and/or divided into further components.

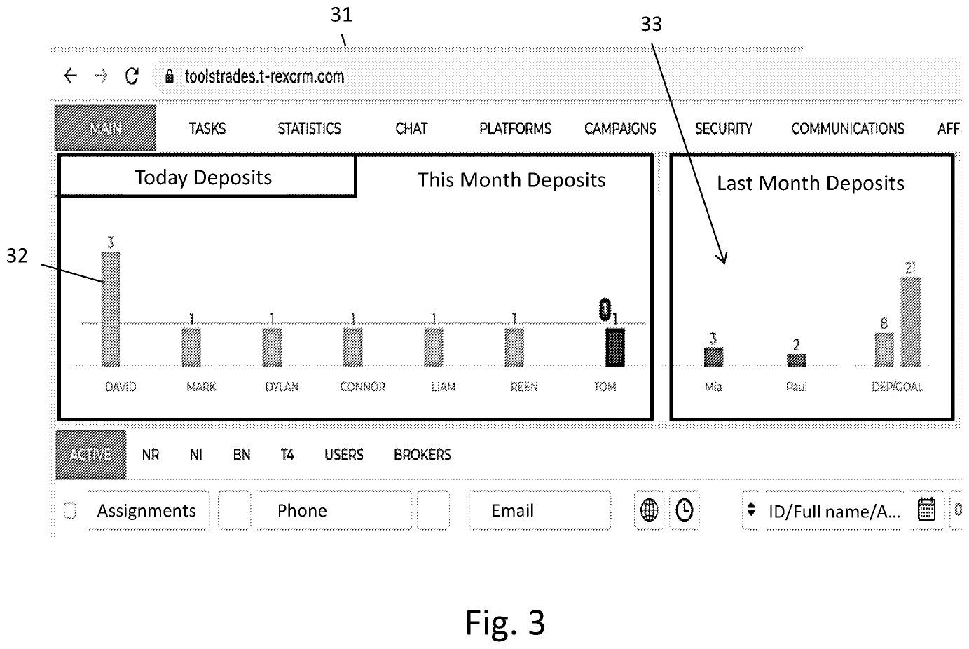

FIGS. 3-5 are example screen layouts of an implementation of the dynamic presentation of the method of the present invention in a contact center environment. The example screen layouts, appearance, and terminology as depicted and described herein, are intended to be illustrative and exemplary, and in no way limit the scope of the invention as claimed.

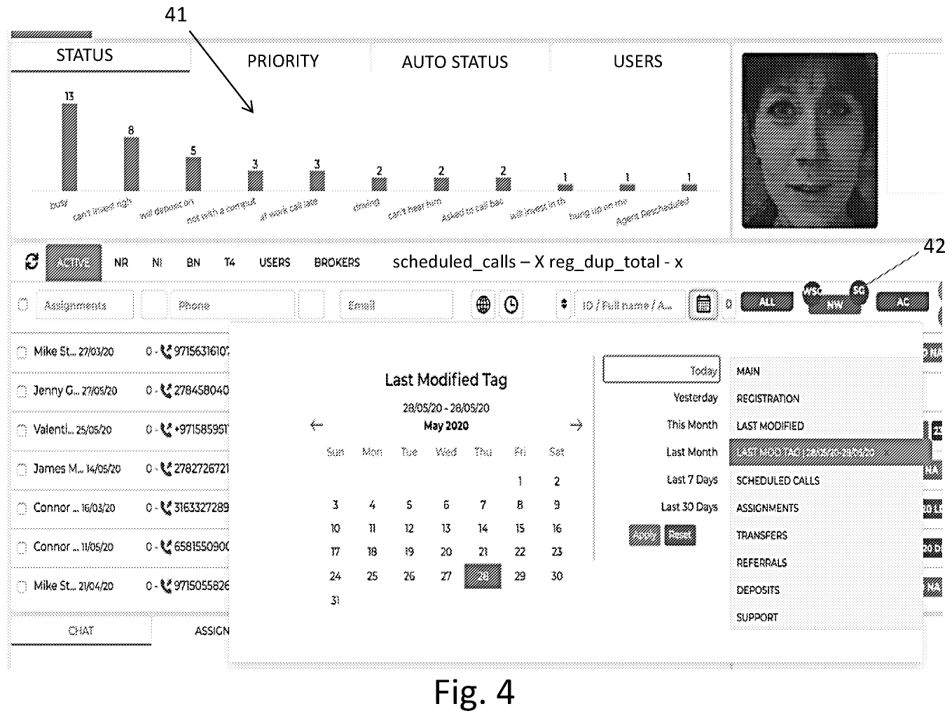

FIG. 3 shows a portion of an example screen layout that displays a live deposit chart 31 of a current month, in comparison to a chart 33 that shows previous month deposits. The information in chart 31 is dynamic and change in real-time according to action taken by active agents. In this example, chart 31 shows that currently, an agent named David has the highest number of deposits (e.g., three deposits as indicated by numeral 32). FIG. 4 shows a portion of an example screen layout that displays a live chart 41 and an example of an implementation of tags-based information 42, according to an embodiment of the invention.

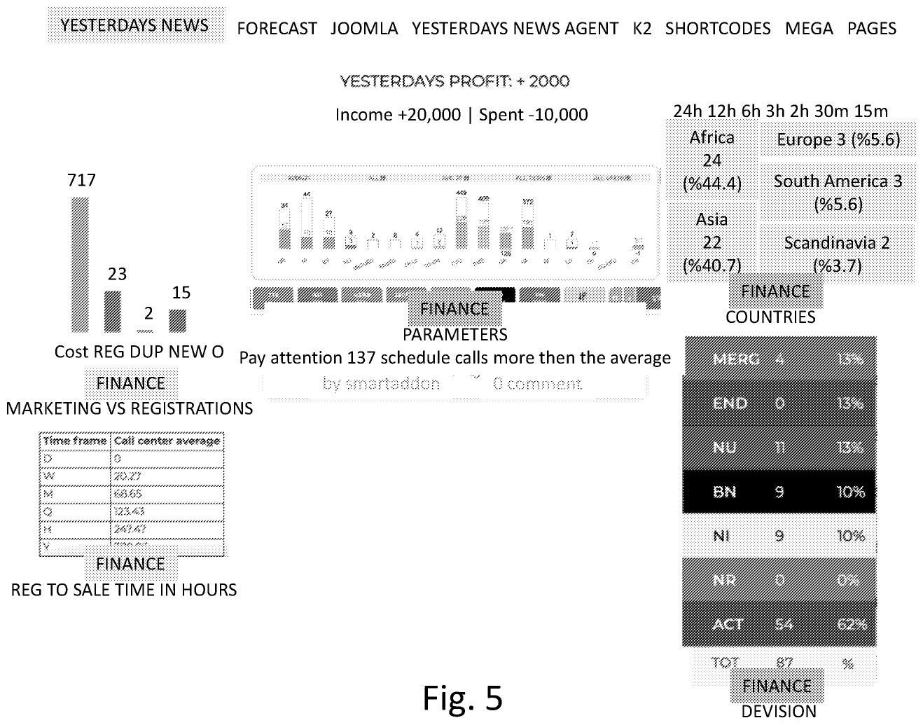

FIG. 5 an example screen layout of a business newspaper form that provides updated inside information of the previous day of a company, according to an embodiment of the invention. For example, an owner of the company may receive (e.g., every morning) financial news about his company describing all needed parameters, wherein the presented information is based on the method of the present invention as described hereinabove. The system may provide forecast news of the day, week, month, quarter, half a year, a year, five years, etc.

All the above descriptions and examples have been given for the purpose of illustration and are not intended to limit the invention in any way. Many different mechanisms, methods of analysis, electronic and logical elements can be employed, all without exceeding the scope of the invention.

1. A computer-implemented method, comprising the steps of:
a. scanning data for determining limited data to work on among data sets that are too large or complex to be dealt with;
b. drilling down to the next data that correlates with the previously determined limited data until obtaining a desired number of workable live results; and
c. saving the results as new data that capture only limited capacity, thereby providing an in-house collection that, due to its limited capacity, information can be retrieved and worked on it live.

2. A method according to claim 1, wherein the scan determines the percentage of data to work on among the entire data set.

3. A method according to claim 1, wherein the percentages of data to work on is about 20% of the entire data set.

4. A method according to claim 1, wherein the desired number of workable live results are up to 1000 workable live results.

5. A method according to claim 1, wherein a procedure to drill down from the entire data set configured to run until reveling the desired number of workable live results.

6. A method according to claim 1, wherein the method is applied in parallel on any other pre-determined outcome to receive multiple outlets and save them as very small data capacity, thereby enabling prompt access and visualization.

7. A method according to claim 1, further comprising assigning a number for each obtained result, wherein each result configured with a top number in accordance with applied statistics score that includes: sum, average, top, and low.

8. A method according to claim 7, further comprising:
saving the data daily in a database and using said saved data to access data calculations;
checking new income data and comparing it to the saved summed up file; and
presenting live suggestions based on said saved data.

9. A method according to claim 1, further comprising applying machine learning process configured for learning from each and every clickable measurement and entered into the database, wherein each click of the button on the system measures time duration.

10. A method according to claim 9, wherein the machine learning process comprises verifying whether a workflow has an outcome by comparing results and updating accordingly, wherein said process involves the steps of:
Once a suggested parameter has been established, it is marked; [need example]; and
Once in a period, the data is collected and updated in accordance with an assigned top number obtained by applied statistics score that includes: sum, average, top, and low.

11. A method according to claim 1, wherein the in-house data collection enables providing live information updates, thus interacting with the system leads to real-time changes in currently displayed data (like the “butterfly effect”).

12. A method according to claim 1, wherein the live information includes data relative to one or more of the following: lead, users, communication, security, marketing, inventory, stats, charts, instructions, shift management, financial, and gamification.

13. A method according to claim 1, further comprising tags-based notifications system, wherein the tags-based notifications system enables to provide real-time data count, timestamp, immediate data filtration and recovery, and speed.

14. A method according to claim 1, further comprising providing positive feedback by gamification, charts, ranking, providing achievements symbols in any category, and live attention.

15. A system, comprising:
c) at least one processor; and
d) a memory comprising computer-readable instructions which when executed by the at least one processor causes the processor to execute an AI workflow, wherein the AI workflow:
iv. scans data for determining limited data to work on among data sets that are too large or complex to be dealt with;
v. drills down to the next data that correlates with the previously determined limited data until obtaining a desired number of workable live results suitable to manage by traditional data-processing application software; and
vi. saves the results as new data that capture only limited capacity, thereby providing an in-house collection that, due to its limited capacity, information can be retrieved and worked on it live.
